(19) United States
(12) Patent Application Publication
(10) Pub. No.: US 2026/0367700 A1
(43) Pub. Date: Nov. 19, 2026

(54) SYSTEMS AND METHODS OF IMPROVING VISUAL LEARNING THROUGH GAZE TRACKING

(71) Applicant: KONINKLIJKE PHILIPS N.V., EINDHOVEN (NL)

(72) Inventors: SIVARAMAN PADMANABHAN, BANGALORE (IN); RAJENDRA SINGH SISODIA, BHOPAL (M.P.) (IN)

(21) Appl. No.: 19/135,832

(22) PCT Filed: Dec. 6, 2023
(86) PCT No.: PCT/EP2023/084511

§ 371 Date: Jun. 5, 2025

Related U.S. Application Data
(60) Provisional application No. 63/431,792, filed on Dec. 12, 2022.

(51) Int. Cl. G06F 3/01; G06T 19/00

(52) U.S. Cl. CPC G06F 3/013; G06T 19/006

(57) ABSTRACT

Methods and systems for improving visual learning through gaze tracking are provided, including methods and systems for assessing participant engagement when conducting an instructional presentation having a visual component. As described herein, the methods and systems of the present disclosure enable improved outcomes, such as improved engagement, in remote and/or virtual instructional scenarios. Further, the methods and systems of the present disclosure may advantageously enable new opportunities for addressing user participation and potential misunderstandings.

### FIELD OF THE DISCLOSURE

The present disclosure relates generally to improving visual learning through gaze tracking, and more specifically to systems and methods of improving visual learning by measuring user engagement through gaze tracking.

### BACKGROUND

For many reasons, remote and/or virtual collaboration and trainings have become increasingly common methods of presenting and otherwise conveying information. Proliferation of wearable augmented reality and the availability of high bandwidth networking solutions have facilitated further technological advancements in this regard. Effective engagement of participants in a visual learning or instructional session (i.e., those viewing or otherwise receiving information) is important for successful remote and/or virtual collaboration. For in-person visual learning or instructional sessions, participant engagement can be determined based on a general observation of a participant's eye-to-eye contact, head movement, facial expressions, and/or verbal responses.

Typically, during such in-person sessions involving visual component, a presenter points to the component while sharing information with the recipient verbally. The presenter obtains cues from where the recipient looks at whether they are looking at an object different from what is expected to be looked at, to know if the recipient is following instructions or not and use that as a non-verbal feedback. In case the recipient is not focusing on where the presenter intends or expects for them to look at, the presenter may employ a redirection prompt, ask for clarification if the recipient has understood or make a correction to the communication style to make the session more engaging and effective. However, in remote and/or virtual scenarios, a presenter cannot easily determine a participant's level of engagement to adjust the style, format, tempo, or other attributes of content delivery.

### SUMMARY OF THE DISCLOSURE

As described herein, Applicants have recognized and appreciated that participant engagement and associated effectiveness of remote collaboration or coaching, training, or instructional sessions involving shared screens or virtual reality spaces can be assessed using concept-based gaze tracking. Further, Applicants have recognized and appreciated that using such gaze tracking can improve engagement and other outcomes in the context of remote collaboration, coaching, training, and/or instructional sessions.

According to an embodiment of the present disclosure, a method for assessing user engagement while conducting a communication session for a participant related to at least one predefined object is provided. The method comprises: defining a gaze focus point associated with the at least one predefined object; establishing a gaze pattern of the participant during the communication session by tracking the gaze focus point relative to the at least one predefined object; determining a level of engagement of the participant based at least in part on analyzing data associated with the gaze pattern of the participant; and adjusting at least one attribute of the communication session based on the determined level of engagement.

In an aspect, the method further comprises communicating the level of engagement at least to the participant.

In an aspect, the level of engagement may be communicated substantially in real time.

In an aspect, the level of engagement may be communicated substantially at preset intervals.

In an aspect, the communication session may be conducted in a virtual reality environment.

In an aspect, the gaze pattern of the participant during the communication session may be established by tracking the gaze focus point relative to manipulation of the at least one predefined object.

In an aspect, the method further comprises communicating a set of prompts associated with the at least one predefined object to the participant, wherein the gaze focus point of the participant is tracked relative to the participant's response to the set of prompts.

In an aspect, the set of prompts may be associated with the manipulation of the at least one predefined object.

In an aspect, the method further comprises mapping a relation between the set of prompts and the at least one predefined object, wherein the mapping is performed using natural language processing and named entity recognition

In an aspect, the participant's response can include verbal feedback.

In an aspect, the at least one attribute of the communication session based on the determined level of engagement may be adjusted automatically.

In an aspect, the at least one attribute of the communication session may include a visual aspect of the communication session, an audible aspect of the communication session, or a combination thereof.

In an aspect, the step of adjusting the at least one attribute of the communication session based on the determined level of engagement may include repeating at least a portion of the communication session after the level of engagement is below a predetermined threshold.

In an aspect, the step of adjusting the at least one attribute of the communication session based on the determined level of engagement may include changing content or delivery of the communication session after the level of engagement falls below a predetermined threshold.

According to another embodiment of the present disclosure, a system for assessing user engagement while conducting a communication session for a participant related to at least one predefined object is provided. The system comprises: a server comprising a memory for storing data related to defining a gaze focus point associated with the at least one predefined object; a camera for capturing a gaze of the participant during the communication session; and one or more processors in communication with the server and the camera, wherein the one or more processors are configured to: establish a gaze pattern of the participant during the communication session by tracking the gaze focus point relative to the at least one predefined object; determine a level of engagement of the participant based at least in part on analyzing data associated with the gaze pattern of the participant; and adjust at least one attribute of the communication session based on the determined level of engagement.

In an aspect, the one or more processors are further configured to communicate the level of engagement at least to the participant substantially in real time.

In an aspect, the one or more processors are further configured to communicate a set of prompts associated with the at least one predefined object to the participant, wherein the gaze focus point of the participant is tracked relative to the participant's response to the set of prompts.

In an aspect, the set of prompts may be associated with a manipulation of the at least one predefined object.

According to yet another embodiment of the present disclosure, a virtual reality system for assessing user engagement while conducting a communication session for a participant related to at least one predefined object is provided. The virtual reality system comprises: a headset that covers at least a partial field of view; a server comprising a memory for storing data related to defining a gaze focus point associated with the at least one predefined object; and one or more processors in communication with the headset and the server, wherein the one or more processors are configured to: establish a gaze pattern of the participant during the communication session by tracking the gaze focus point relative to the at least one predefined object; determine a level of engagement of the participant based at least in part on analyzing data associated with the gaze pattern of the participant; and adjust at least one attribute of the communication session of the participant based on the determined level of engagement.

In an aspect, the at least one attribute of the communication session based on the determined level of engagement may be adjusted automatically.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram illustrating the use of a system for assessing user engagement according to aspects of the present disclosure.

FIG. 2 is a block diagram of a system for assessing user engagement according to aspects of the present disclosure.

FIG. 3 is a block diagram of a participant engagement analyzer according to aspects of the present disclosure.

FIG. 4A is an illustration showing a focus point pattern according to aspects of the present disclosure.

FIG. 4B is an illustration showing a gaze pattern associated with the focus point pattern of FIG. 4A according to aspects of the present disclosure.

FIG. 5A is a diagram illustrating focal differences in a communication session according to aspects of the present disclosure.

FIG. 5B is a diagram illustrating how to calculate focal differences according to aspects of the present disclosure.

FIG. 6 is a flowchart illustrating a method of assessing user engagement according to aspects of the present disclosure.

FIG. 7 is a diagram illustrating a virtual reality system for assessing user engagement according to aspects of the present disclosure.

### DETAILED DESCRIPTION OF EMBODIMENTS

The present disclosure is directed to methods and systems for improving visual learning through gaze tracking. More specifically, the present disclosure is directed to methods and systems for assessing user or participant engagement during remote communication session having a shared visual component including at least one predefined object. Examples of such remote communication sessions include, but are not limited to instructional presentations, technical support, training or coaching sessions, or team collaborations. In embodiments, a remote communication session may be conducted virtually and/or remotely, either in a two-dimensional collaborative space (e.g., involving a shared screen) and/or in a three-dimensional collaborative space (e.g., a virtual reality or mixed-reality environment). In particular embodiments, the remote communication session includes at least a visual component (i.e., viewable to participants), but can also include other components, such as audio components, tactile components, interactive components, and the like.

As described herein, the methods and systems of the present disclosure enable improved outcomes, such as improved engagement, in remote and/or virtual instructional scenarios. Further, the methods and systems of the present disclosure may advantageously enable new opportunities for addressing user participation and potential misunderstandings.

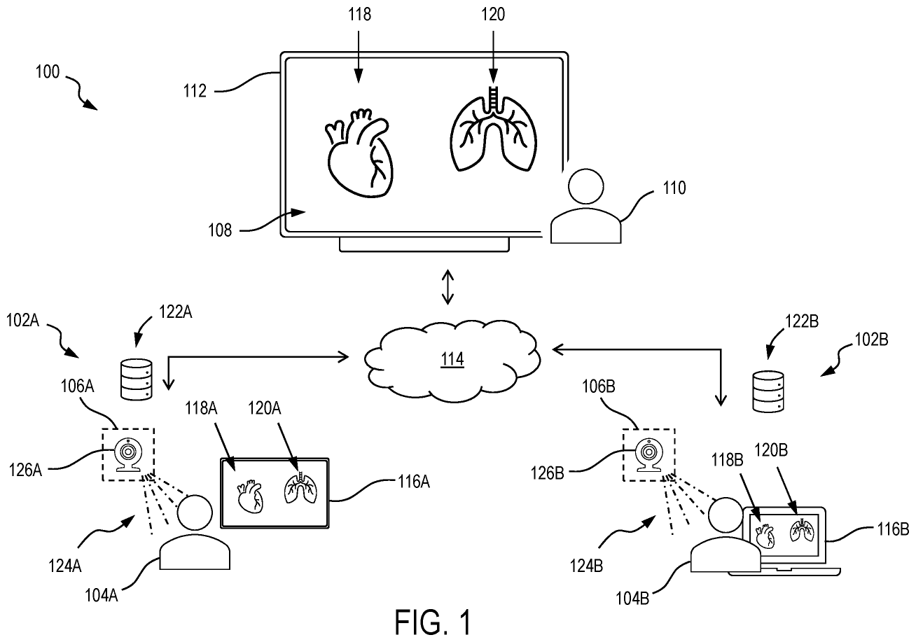

Turning to FIG. 1, a diagram showing the performance of a communication session 100 and the use of one or more systems 102A, 102B configured to assess a level of engagement for one or more participants 104A, 104B is illustrated according to aspects of the present disclosure. As described herein, the systems 102A, 102B can be configured to assess the level of engagement for one or more participants 104A, 104B while conducting the communication session 100 using a gaze-tracking apparatus 106A, 106B.

According to the present disclosure, a communication session 100 refers to an informational presentation containing a visual component 108 that can be transmitted or otherwise presented to one or more participants 104A, 104B. In some embodiments, the communication session 100 can be a two-dimensional virtual environment, such as a view of a shared screen or shared monitor, a two-dimensional virtual reality environment, and/or a two-dimensional augmented reality environment. In further embodiments, the communication session 100 can be a three-dimensional virtual environment, such as a shared virtual reality environment and/or an augmented reality environment. In some embodiments, the communication session 100 can be live (i.e., transmitted or presented in real-time to the one or more participants 104A, 104B), can be pre-recorded, or a combination of live and pre-recorded.

In embodiments, the communication session 100 may be presented by one or more hosts 110.

For example, in embodiments, the host 110 may be virtually sharing an instructional presentation (i.e., including the visual component 108) from a host device 112. The communication session 100 can be transmitted or otherwise presented to the one or more participants 104A, 104B over a communications network 114 (as discussed in more detail below) via one or more participant devices 116A, 116B. In embodiments, the communication session 100 can be transmitted or otherwise presented to the one or more participants 104A, 104B simultaneously and/or at different times.

Each of the one or more participants 104A, 104B receive, view, and/or otherwise participate in the communication session 100 within proximity to a system 102A, 102B configured to assess user engagement. As described herein, user engagement may be assessed in relation to one or more visual aspects 118, 120 of the visual component 108 of the communication session 100. More specifically, user engagement may be assessed using gaze-tracking in relation to the one or more visual aspects 118, 120 of the visual component 108 of the communication session 100, which are transmitted or otherwise visually presented to the one or more participants 104A, 104B (e.g., predefined objects 118A, 118B, 120A, 120B).

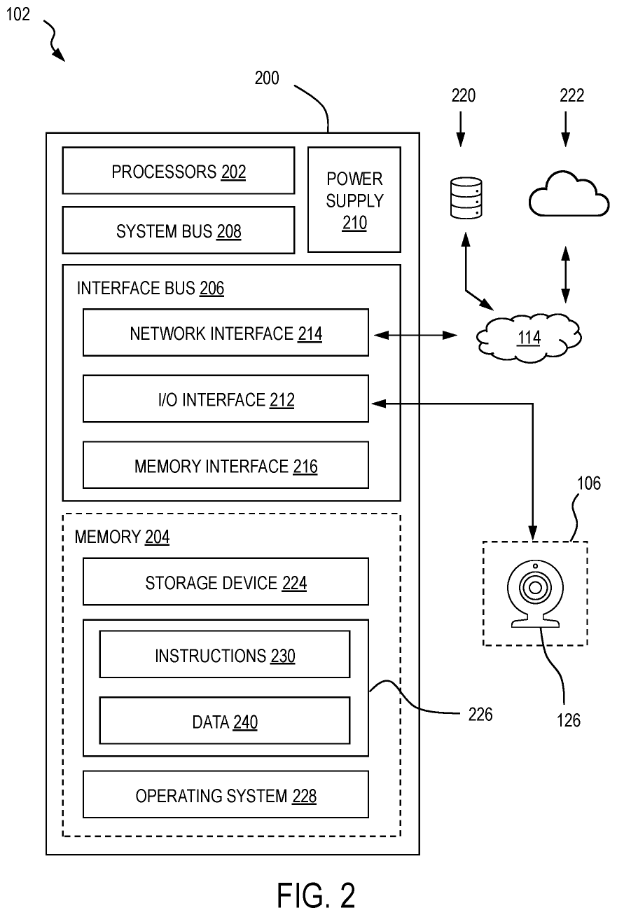

The system 102A, 102B for assessing user engagement during the communication session 100 can comprise at least: (i) a remote server 122A, 122B comprising a memory for storing data related to defining a gaze focus point associated with at least one predefined object 104B (e.g., predefined objects 118A, 118B, 120A, 120B); (ii) a gaze-tracking apparatus 106A, 106B configured to record a plurality of images capturing the eye movement of one or more participants 104A, 104B and/or muscle response/electrical activity associated with eye movement for one or more participants 104A, 104B; and (iii) one or more processors (e.g., processors 202 shown in FIG. 2) in communication with the server 122A, 122B and the gaze-tracking apparatus 106A, 106B.

In embodiments, the one or more processors (e.g., processors 202 shown in FIG. 2) can be configured perform one or more steps of the methods described herein, including but not limited to, the following: (i) defining a gaze focus point associated with the at least one predefined object (e.g., predefined objects 118A, 118B, 120A, 120B); (ii) establishing a gaze pattern of the participant(s) 104A, 104B during the communication session 100 by tracking the gaze focus point relative to the at least one predefined object (e.g., predefined objects 118A, 118B, 120A, 120B); (iii) determining a level of engagement of the participants 104A, 104B based at least in part on analyzing data associated with the gaze pattern of the participant(s) 104A, 104B; and (iv) adjusting at least one attribute of the communication session 100 based on the determined level of engagement for the participant(s) 104A, 104B.

In embodiments, the gaze-detection apparatus 106A, 106B can include one or more components configured to measure and record the facial features of one or more individuals (e.g., participants 104A, 104B) within a corresponding field-of-view 124A, 124B. According to certain aspects, the gaze-detection apparatus 106A, 106B may include an eye tracking-enabled camera 126A, 126B. In further aspects, the gaze-detection apparatus 106A, 106B can include muscle-based eye-tracking system, such as an electromyography (EMG) device. As such, the gaze-detection apparatus 106A, 106B can be configured to generate eye-gaze data, which can include, for example and without limitation, a plurality of images capturing the eye movement of one or more participants 104A, 104B and/or muscle response/electrical activity associated with eye movement.

In embodiments, the server 122A, 122B can include a memory that stores instructions for defining one or more gaze focus points associated with one or more predefined objects (e.g., predefined objects 118A, 118B, 120A, 120B). In embodiments, the one or more processors (e.g., processors 202 shown in FIG. 2) can be operatively connected to and/or in communication with the gaze-detection apparatus 106A, 106B such that the one or more processors 202 may receive the eye-gaze data. Similarly, the one or more processors 202 can be operatively connected to and/or in communication with the server 122A, 122B such that the one or more processors 202 can use the instructions for defining one or more gaze focus points associated with one or more predefined objects 118A, 118B, 120A, 120B and determine a gaze pattern for one or more participants 104A, 104B.

With further reference to FIG. 2, the system 102 (e.g., systems 102A, 102B) can include an electronic device 200 that includes the one or more processors 202. In embodiments, the device 200 may comprise one or more processors 202 (also referred to as central processing units or CPUs), machine-readable memory 204, an interface bus 206, all of which may be interconnected and/or communicate through a system bus 208 containing conductive circuit pathways through which instructions (e.g., machine-readable signals) may travel to effectuate communications, tasks, storage, and the like. The device 200 may be connected to a power source 210, which can include an internal power source and/or an external power source.

In embodiments, the one or more processors 202 can comprise a high-speed data processor adequate to execute program components, which may include various specialized processing units as may be known in the art. The general processor may be a microprocessor, or may also be any traditional processor, controller, microcontroller, or state machine. In some embodiments, one or more of the features described herein may be implemented on components such as an Application-Specific Integrated Circuit (“ASIC”), a Digital Signal Processor (“DSP”), a Field Programmable Gate Array (“FPGA”), a Graphics Processing Unit (“GPU”), and/or similar electronics.

In embodiments, the interface bus 206 may include an input/output interface 212 configured to connect the device 200 to one or more peripheral devices (e.g., the gaze-detection apparatus 106), a network interface 214 configured to connect the device 200 to a communications network 114 (e.g., using a network protocols such as IEEE 802.3 and/or 802.11), and/or a memory interface 216 configured to accept, communicate, and/or connect to a number of machine-readable memory devices (e.g., storage device 224, removable storage devices, etc.).

In aspects, the network interface 214 operatively connects the device 200 to a communications network 114, which can include a direct interconnection, the Internet, a local area network (“LAN”), a metropolitan area network (“MAN”), a wide area network (“WAN”), a wired or Ethernet connection, a wireless connection, and similar types of communications networks, including combinations thereof. In some embodiments, one or more user servers 220 and/or cloud-based services 222 may connect with the device 200 via the communications network 114 and the network interface 214.

The memory 204 can be variously embodied in one or more forms of machine-accessible and machine-readable memory. In some examples, the memory 204 includes a storage device 224 comprises one or more types of memory. For example, the storage device 224 can include, but is not limited to, a non-transitory storage medium, a magnetic disk storage, an optical disk storage, an array of storage devices, a solid-state memory device, and the like, including combinations thereof.

Generally, the memory 204 is configured to store data/information 240 and instructions 230 that, when executed by the one or more processors 202, causes the device 200 to perform one or more tasks. In embodiments, memory 204 can include an engagement analyzer 226 that includes a collection of programs and/or database components and/or data. Depending on the particular implementation, the engagement analyzer 226 may include software components, hardware components, and/or some combination of both hardware and software components.

In particular embodiments, the engagement analyzer 226 and/or one or more individual software packages may be stored in a local storage device 224. In other examples, the engagement analyzer 226 and/or one or more individual software packages may be loaded onto and/or updated from a remote server 220 via the communications network 114.

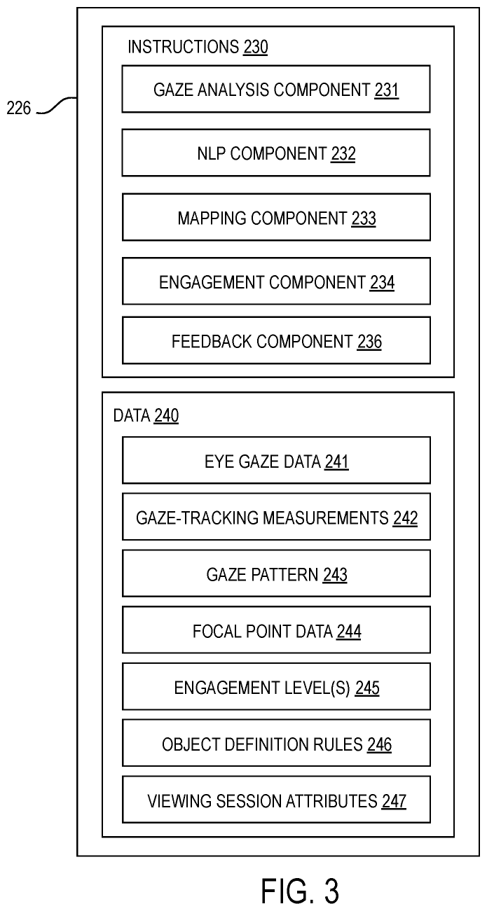

For example, with reference to FIG. 3, the engagement analyzer 226 can include, but is not limited to, instructions 230 having a gaze analysis component 231, a natural language processing (“NLP”) component 232, a mapping component 233, an engagement component 234, and/or a feedback component 236. These components may be incorporated into, loaded from, loaded onto, or otherwise operatively available to and from the system 102. Similarly, the device 200 or portions thereof can be incorporated into, loaded from, loaded onto, or otherwise operatively available to and from the system 200. For example, although program components may be stored in a local storage device 224, they may also be loaded and/or stored in other memory, such as a remote cloud storage facility accessible through a communications network (e.g., communications network 114).

The gaze analysis component 231 can be a stored program component that is executed by at least one processor, such as the one or more processors 202 of the device 200. In embodiments, the gaze analysis component 231 can receive the gaze data 241 as an input and analyze the gaze data 241 to determine one or more gaze-tracking measurements 242 associated with at least one participant 104A, 104B. In certain embodiments, these gaze-tracking measurements 242 can include, but are not limited to, fixation count, regressive fixation count, fixation duration, amplitude, saccade peak velocity, blink rate or inter-blink interval, blink amplitude and blink duration, phasic pupil diameter, tonic pupil diameter, and the like. Each of these measurements are summarized in Table 1 below.

TABLE 1

| MEASUREMENT | UNITS | DESCRIPTION |
|---|---|---|
| Fixation location | Distance | Related to the position of the eye as it fixates on a particular |
| | | region |
| Fixation count | Frequency count | The number of times the eye fixates in a particular region of |
| | | interest, related to at least: the salience of the area, the |
| | | informational value of the area, how much information is |
| | | available in a single fixation, or the processing difficulty of |
| | | the information |
| Regressive fixation | Frequency count | Re-fixating a previously fixated region, to resolve ambiguity |
| count | | or other processing difficulties |
| Fixation duration | Milliseconds | How long the eye fixates on a region prior to a saccade, |
| | | related to the difficulty in processing the information in that |
| | | region, the value of the information available in that region, |
| | | the time needed to plan the next saccade, and the predicted |
| | | value of information available following the next saccade |
| Amplitude | Degrees | The magnitude of a saccade, influenced by how much |
| | | information can be processed in the area of a single fixation, |
| | | and the distance to the next planned fixation target |
| Saccade peak | Degrees/second | The maximum speed achieved within a saccade, related to |
| velocity | | physiological arousal, mental workload, or the predicted |
| | | value of information available at the subsequent fixation |
| Blink rate or inter- | Frequency count or | The number of eye blinks detected by an eye tracker's |
| blink interval | time (milliseconds) | algorithms, inversely related to physiological arousal, |
| | | wakefulness, processing difficulty, motivation, and mental |
| | | workload |
| Blink amplitude | Millisecond | The extent and duration of an eye blink (temporary closure) |
| and blink duration | | event, inversely related to physiological arousal, |
| | | wakefulness, processing difficulty, motivation, and mental |
| | | workload |
| Phasic pupil | Millimeter | Rapid and dramatic pupil diameter changes related to |
| diameter | diameter | processing task- and goal-relevant information, and |
| | | exploiting that information to perform a task |
| Tonic pupil | Millimeter | Sustained pupil diameter changes that establish a new |
| diameter | diameter | baseline diameter from which phasic responses deviate, |
| | | related to sustained cognitive processing, task difficulty, |
| | | cognitive effort, arousal, and vigilance |

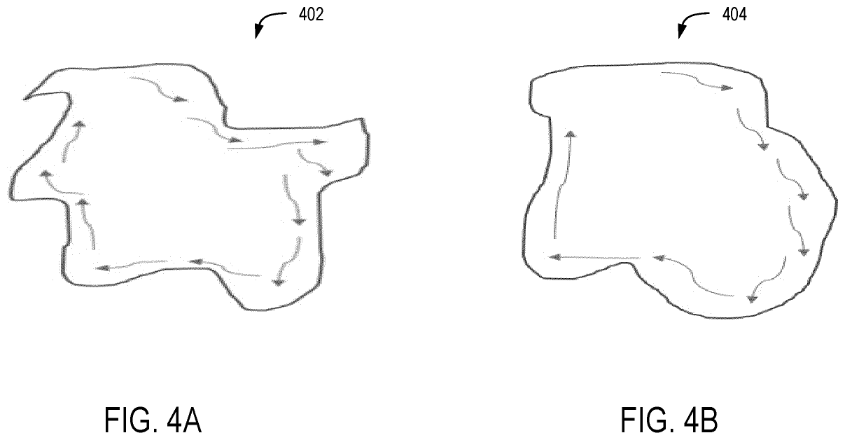

In particular embodiments, the gaze analysis component 231 can be configured to establish a gaze pattern 243 for at least one participant 104A, 104B during a communication session 100 based on one or more gaze-tracking measurements 242. In embodiments, a gaze pattern 243 can comprise a time-coded sequence of gaze-tracking measurements 242, which can be compared with, for example, a time-coded gaze focus point for one or more predefined objects (e.g., visual objects 118A, 118B, 120A, 120B) visible to the participant(s) 104A, 104B. For example, with reference to FIGS. 4A and 4B, a focal point pattern 402 for one or more predefined objects of a communication session 100 is illustrated over a first time window. Over the same time window, a gaze pattern 404 for a participant (e.g., participant 104A, 104B) measured according to the present disclosure is illustrated. In embodiments, gaze pattern 404 can be stored as gaze pattern data 243.

Accordingly, in embodiments, the gaze pattern data 243 and/or gaze pattern 404 for each participant 104A, 104B can be analyzed relative to one or more predefined objects 118A, 118B, 120A, 120B to determine a level of engagement for the participant 104A, 104B. In some embodiments, the engagement analyzer 226 can include an engagement component 234 configured to analyze the gaze pattern data 243 and/or gaze pattern 404 for one or more participants 104A, 104B relative to the one or more predefined objects 118A, 118B, 120A, 120B to determine a level of engagement for the participant 104A, 104B. In particular embodiments, the engagement component 234 is configured to analyze the gaze pattern data 243 and/or gaze pattern 404 for one or more participants 104A, 104B relative to a focal point pattern 402 one or more predefined objects 118A, 118B, 120A, 120B to determine a level of engagement for the participant 104A, 104B.

In embodiments, the engagement component 234 can be a stored program component that is executed by at least one processor, such as the one or more processors 202 of the device 200. In particular, the engagement component 234 may receive the gaze-tracking measurements 242, gaze pattern data 243, and/or focal point pattern data 244 as inputs. The engagement component 234 may then generate a level of engagement 245 for one or more participants 104A, 104B based thereon. That is, the engagement component 234 may analyze the gaze-tracking measurements 242, gaze pattern data 243, and/or focal point pattern data 244 for at least one participant 104A, 104B of a communication session 100 to determine at least one measurement of the level of engagement 245 for the participant 104A, 104B.

In particular embodiments, for example, the level of engagement 245 for a participant 104A, 104B may be evaluated based on the focal difference (e.g., Δ_{focal}) between a fixation location of the participant 104A, 104B and the gaze focus point associated with one or more predefined objects 118A, 118B, 120A, 120B. For example, the focal difference (e.g., Δ_{focal}) can be calculated as follows:

Δ_{focal}=\sqrt{(x₁−x₂)²+(y₁−y₂)²+(z₁−z₂)²} (Eqn. 1)

where (x₁, y₁, z₁) are the coordinates of the fixation location and (x₂, y₂, z₂) are the coordinates of the gaze focus point for a predefine object.

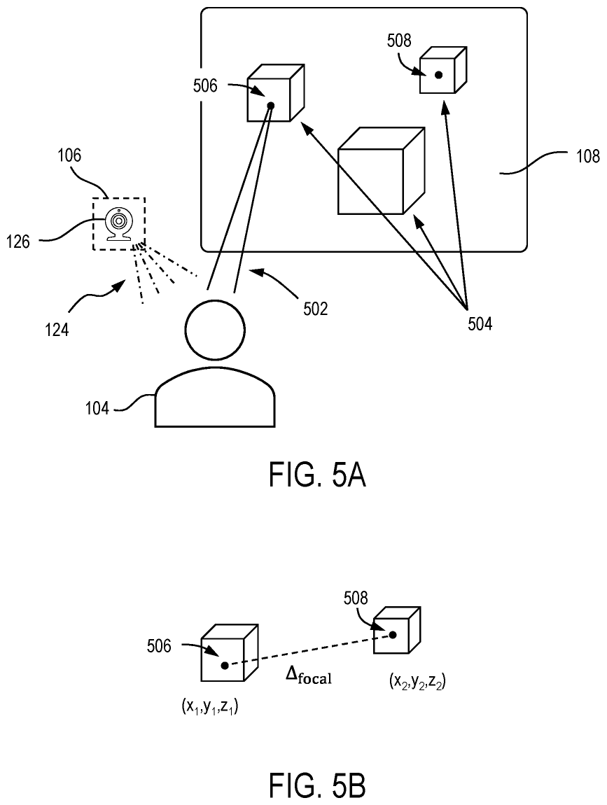

With reference to FIGS. 5A and 5B, a diagram of illustrating how the level of engagement 245 of a participant 104 viewing a visual component 108 of a communication session (e.g., communication session 100) may be determined according to aspects of the present disclosure. As shown, a gaze-tracking apparatus 106 can be used to track the gaze 502 of the participant 104 within a field of view 124 while the participant 104 views the visual component 108 of the communication session. The visual component 108 can comprise one or more predefined objects 504, and based on the information captured by the gaze-tracking apparatus 106, it can be determined that the gaze 502 of the participant 104 is directed to a first object 506 rather than a second object 508. In embodiments, the second object 508 may be the intended focus point, and therefore the gaze 502 of the participant 104 indicates a loss of focus. As shown in FIG. 5B, the coordinates of the fixation location (e.g., at object 506) and the coordinates of the gaze focus point (e.g., at object 508) can be determined by the systems of the present disclosure (e.g., systems 102A, 102B) and the focal difference can then be calculated.

In embodiments, the level of engagement 245 for a participant 104A, 104B may be evaluated as a weighted or unweighted average of the focal differences calculated over a period of time (e.g., such as over the entire duration of a communication session) as follows:

$${E}_{session} = \frac{1}{N} \sum {Δ}_{focal} \qquad ( Eqn . 2 )$$

where Eₛₑₛₛᵢₒₙ is a measure of a participant's engagement level over a communication session or a portion thereof, N is the number of samples of Δ_{focal} calculated over the session or a portion thereof, and ΣΔ_{focal} is the sum of Δ_{focal} at the N points in time.

According to the present disclosure, the focal point data 244 (i.e., gaze focus points and focal point patterns associated with one or more predefined objects) can be determined and/or defined according to predefined object definition rules 246. In some embodiments, the object definition rules 246 can include rules for tracking a pointing device, such as a virtual laser pen, a mouse cursor, and/or the like.

In other embodiments, the object definition rules 246 includes rules for analyzing an audio component of the communication session 100 to identify the one or more predefined objects and define a gaze focus point(s). For example, in some embodiments, a natural language processing component 232 can be used to process an audio component of the communication session 100 and extract a domain concept using a domain dictionary or ontology. The domain concept identified by the NLP component 232 can then be mapped by a mapping component 233 to the visual elements of the communication session 100. For instance, in the example of FIG. 1, the host or presenter 110 is sharing a visual component 108 that includes a depiction of a heart 118 and a pair of lungs 120. In an audio component, the presenter 110 may refer to the “heart”, which the NLP component 232 can identify while the mapping component 233 can identify the location of the heart 118 relative to the visual component 108 at the time of the utterance.

In embodiments, the mapping component 233 can include a named entity recognition (NER) engine configured to associate aspects or concepts in one part of the communication session 100 (e.g., an audio component) with another part of the communication session 100 (e.g., a visual component). In some embodiments, the mapping component 233 can include a machine learning algorithm, such as convolutional neural networks, to detect objects identified by the NLP component 232. In particular embodiments, the mapping component 233 can include a YOLO algorithm configured to detect objects identified by the NLP component 232.

Put another way, the host 110 may communicate one or more prompts audibly, visually, or both, which associated with the at least one predefined object (e.g., by stating aloud “heart”) to the participants 104A,104B, wherein the gaze focus point of the participants 104A, 104B is tracked relative to the participants' responses to the set of prompts. In some embodiments, a participant's response may be received verbally (i.e., in audio form). In this manner, a time-coded identification of focal point information 244 can be generated and used to compare with gaze-tracking measurements 242 and/or gaze patterns 243 for one or more participants 104A, 104B.

In embodiments, the natural language processing component 232 can be a stored program component that is executed by at least one processor, such as the one or more processors 202 of the device 200. It will be understood by those of skill in the art that natural language processing refers to a branch of artificial intelligence that combines computational linguistics (i.e., rule-based modeling of human language) with statistical, machine learning, and deep learning models in order to process human language in the form of text or voice data. Similarly, the mapping component 233 can be a stored program component that is executed by at least one processor, such as the one or more processors 202 of the device 200. In embodiments, the mapping component 233 includes an artificial intelligence algorithm that uses image processing, convolutional neural networks, and machine learning models in order to identify visible objects in two- or three-dimensional spaces.

In embodiments, engagement analyzer 226 can further include a feedback component 234 configured to provide feedback in relation to the communication session 100. For example, the feedback component 234 can be configured to communicate with the hosts or presenters 110 of the communication session 100 and/or one or more participants 104A, 104B of the communication session 100 and provide feedback to either the presenters 110 or participants 104A, 104B. In some embodiments, the feedback can include an indication of poor engagement.

In further embodiments, the feedback component 234 can be configured to adjust one or more attributes 247 of the communication session 100 based on the determined level of engagement 245. For example, the feedback component 234 may modify certain attributes 247 of the display visible to the participants 104A, 104B, provide alerts to either the host 110 or participants 104A, 104B, and the like. In embodiments, adjusting an attribute 247 of the communication session 100 can include emphasizing certain information (whether visually, audibly, or a combination thereof), or repeating and/or reproducing certain information (whether visually, audibly, or a combination thereof).

In some embodiments, the feedback component 234 can provide feedback tailored to a level of engagement 245 determined for each participant 104A, 104B. That is, in some embodiments, a first participant 104A may receive different feedback than a second participant 104B based on a different evaluation of the participants' 104A, 104B engagement levels.

In particular embodiments, the feedback includes at least communicating the level of engagement determined for at least one participant 104A, 104B. In embodiments, the level of engagement determined for at least one participant 104A, 104B may be communicated in real time or substantially in real time (with minimal delays), or may be communicated at preset intervals (e.g., breaks, paused, or periodically).

The memory 204 of the device 200 can also include an operating system component 228. The operating system component 228 can be an executable program component facilitating the operation of the device 200. Typically, the operation system component 228 is configured to facilitate access of the I/O, network, and storage interfaces, and may communicate with other components of the device 200.

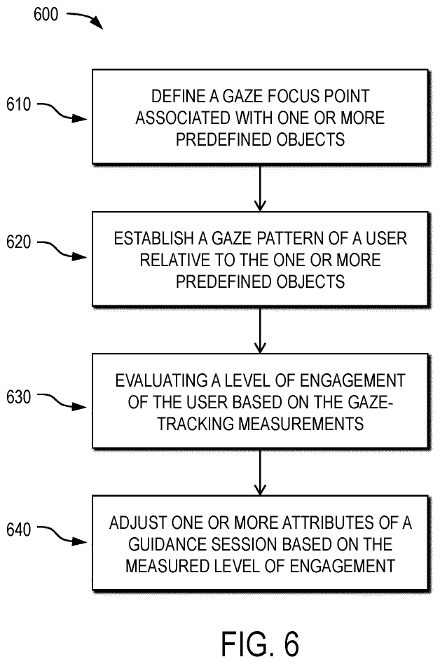

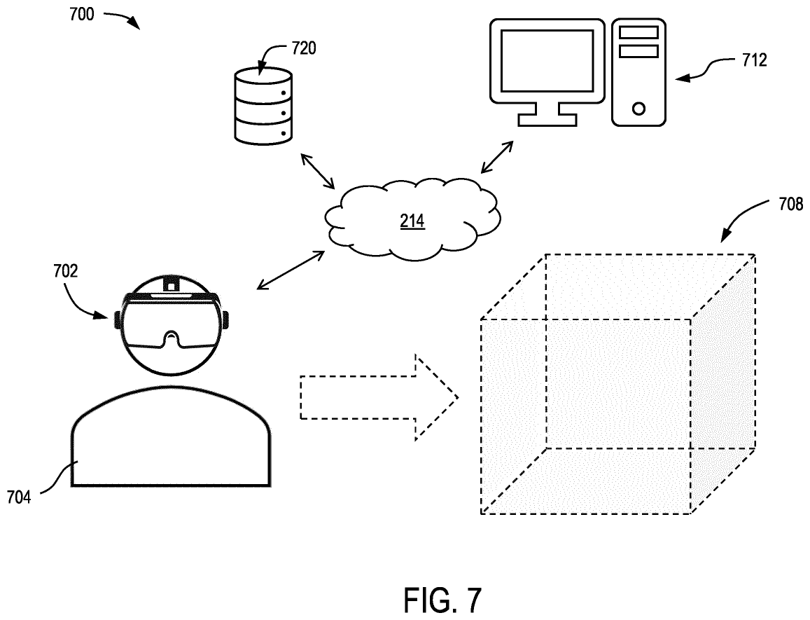

Turning now to FIG. 6, a method 600 for assessing user engagement while conducting a communication session 100 for a participant 104A, 104B related to at least one predefined object 118A, 118B, 120A, 120B is illustrated according to aspects of the present disclosure. In embodiments, the method 600 comprises: in a step 610, defining a gaze focus point associated with the at least one predefined object; in a step 620, establishing a gaze pattern of the participant during the communication session by tracking the gaze focus point relative to the at least one predefined object; in a step 630, determining a level of engagement of the participant based at least in part on analyzing data associated with the gaze pattern of the participant; and in a step 640, adjusting at least one attribute of the communication session based on the determined level of engagement. In embodiments, the method 600 can further comprise communicating feedback (e.g., a determined level of engagement) to the participant 104A, 104B or the presenter 110, as described above.

In embodiments, step 640 of the method 600 includes automatically adjusting at least one attribute of the communication session 100 based on the determined level of engagement. For example, in some embodiments, step 640 can include repeating at least a portion of the communication session 100 if the level of engagement for one or more participants 104A, 104B falls below a predetermined threshold. In further embodiments, step 640 can include changing the content or delivery of the communication session once the level of engagement of one or more participants 104A, 104B falls below a predetermined threshold.

In further embodiments, the method 600 includes communicating a set of prompts associated with the at least one predefined object to the participant, wherein the gaze focus point of the participant is tracked relative to the participant's response to the set of prompts. In some embodiments, the set of prompts is associated with the manipulation of the at least one predefined object. As described above, the method 500 can include mapping a relation between the set of prompts and the at least one predefined object (e.g., using natural language processing and named entity recognition, etc.).

As described herein, the systems 102A, 102B, gaze-tracking apparatuses 106A, 106B, and methods 600 can be utilized in two-dimensional or three-dimensional virtual spaces. That is, in some embodiments, the communication session 100 may be conducted in two-dimensional environment (e.g., on a computer monitor, tablet, phone screen, etc.), but may also be conducted in a three-dimensional environment (e.g., a virtual reality environment).

Accordingly, also provided herein are virtual reality systems 700 comprising: (i) a headset 702 that covers at least a partial field of view for a participant 704; (ii) a server 720 comprising a memory (e.g., memory 204) for storing data related to defining a gaze focus point associated with one or more predefined objects; and (iii) one or more processors (e.g., processors 202) in communication with the headset 702 and the server 720, wherein the one or more processors are configured to: establish a gaze pattern (e.g., gaze pattern 243, etc.) of the participant 704 during the communication session by tracking the gaze-related data (e.g., gaze focus point 244, etc.) relative to the at least one predefined object (e.g., objects 118A, 118B, 120A, 120B); determine a level of engagement (e.g., engagement levels 245) of the participant 704 based at least in part on analyzing data associated with the gaze pattern of the participant 704; and adjust at least one attribute of the communication session visible to the participant 704 based on the determined level of engagement. In such embodiments, the communication session can be presented to the participant 704 via the headset 702 in the form of a three-dimensional virtual reality environment 708.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

As used herein, reference numbers followed by a letter (“A”, “B”, “C”, etc.) are utilized to assist in identification of elements or features similar to those bearing the same base reference number across different embodiments, but while facilitating further discussion with respect to the particular features in separate embodiments. It should be appreciated that features or elements having a base reference numeral appended with a letter are generally arranged and function as described with respect to that element or feature that share the base reference number, except as otherwise indicated.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the FIGS. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A method for assessing user engagement while conducting a communication session for a participant related to at least one predefined object, the method comprising:
defining a gaze focus point associated with the at least one predefined object;
establishing a gaze pattern of the participant during the communication session by tracking the gaze focus point relative to the at least one predefined object;
determining a level of engagement of the participant based at least in part on analyzing data associated with the gaze pattern of the participant; and
adjusting at least one attribute of the communication session based on the determined level of engagement.

2. The method of claim 1, further comprising:
communicating the level of engagement at least to the participant.

3. The method of claim 2, wherein the level of engagement is communicated substantially in real time.

4. The method of claim 2, wherein the level of engagement is communicated substantially at preset intervals.

5. The method of claim 1, wherein the communication session is conducted in a virtual reality environment.

6. The method of claim 1, wherein the gaze pattern of the participant during the communication session is established by tracking the gaze focus point relative to manipulation of the at least one predefined object.

7. The method of claim 1, further comprising:
communicating a set of prompts associated with the at least one predefined object to the participant, wherein the gaze focus point of the participant is tracked relative to the participant's response to the set of prompts.

8. The method of claim 7, wherein the set of prompts is associated with the manipulation of the at least one predefined object.

9. The method of claim 7, further comprising:
mapping a relation between the set of prompts and the at least one predefined object, wherein the mapping is performed using natural language processing and named entity recognition

10. The method of claim 7, wherein the participant's response includes verbal feedback.

11. The method of claim 1, wherein the at least one attribute of the communication session based on the determined level of engagement is adjusted automatically.

12. The method of claim 1, wherein the at least one attribute of the communication session includes a visual aspect of the communication session, an audible aspect of the communication session, or a combination thereof.

13. The method of claim 1, wherein adjusting the at least one attribute of the communication session based on the determined level of engagement comprises:
repeating at least a portion of the communication session after the level of engagement is below a predetermined threshold.

14. The method of claim 1, wherein adjusting the at least one attribute of the communication session based on the determined level of engagement comprises:
changing content or delivery of the communication session after the level of engagement falls below a predetermined threshold.

15. A system for assessing user engagement while conducting a communication session for a participant related to at least one predefined object, the system comprising:
a server comprising a memory for storing data related to defining a gaze focus point associated with the at least one predefined object;
a camera for capturing a gaze of the participant during the communication session; and
one or more processors in communication with the server and the camera, wherein the one or more processors are configured to:
establish a gaze pattern of the participant during the communication session by tracking the gaze focus point relative to the at least one predefined object;
determine a level of engagement of the participant based at least in part on analyzing data associated with the gaze pattern of the participant; and
adjust at least one attribute of the communication session based on the determined level of engagement.

16. The system of claim 15, wherein the one or more processors are further configured to:
communicate the level of engagement at least to the participant substantially in real time.

17. The system of claim 15, wherein the one or more processors are further configured to:
communicate a set of prompts associated with the at least one predefined object to the participant, wherein the gaze focus point of the participant is tracked relative to the participant's response to the set of prompts.

18. The system of claim 17, wherein the set of prompts is associated with a manipulation of the at least one predefined object.

19. A virtual reality system for assessing user engagement while conducting a communication session for a participant related to at least one predefined object, the system comprising:
a headset that covers at least a partial field of view;
a server comprising a memory for storing data related to defining a gaze focus point associated with the at least one predefined object; and
one or more processors in communication with the headset and the server, wherein the one or more processors are configured to:
establish a gaze pattern of the participant during the communication session by tracking the gaze focus point relative to the at least one predefined object;
determine a level of engagement of the participant based at least in part on analyzing data associated with the gaze pattern of the participant; and
adjust at least one attribute of the communication session of the participant based on the determined level of engagement.

20. The virtual reality system of claim 19, wherein the at least one attribute of the communication session based on the determined level of engagement is adjusted automatically.
